(19) United States
(12) Patent Application Publication
(10) Pub. No.: US 2008/0199289 A1
(43) Pub. Date: Aug. 21, 2008

(54) Method and Device For Emptying Containers

(75) Inventor: Gerhard Schafer, Neunkirchen (DE)

Correspondence Address: COLLARD & ROE, P.C., 1077 NORTHERN BOULEVARD, ROSLYN, NY, 11576, US

(73) Assignee: SSI SCHÄFER PEEM GMBH, Graz (AT)

(21) Appl. No.: 11/597,011

(22) PCT Filed: May 12, 2005
(86) PCT No.: PCT/AT05/00161

§ 371 Date: Nov. 17, 2006

(30) Foreign Application Priority Data
May 18, 2004 (AT) A 875/2004

(51) Int. Cl. B65G 65/23

(52) U.S. Cl. 414/404; 414/810

(57) ABSTRACT

The invention relates to a method and a device for emptying transport containers that are transported by transport devices. At least one gripper device is arranged over a support surface having at least one opening. A control controls the gripper device and occasions the gripper to clamp the transport container at its side walls that are oriented in parallel to the direction of transport and to lift it off the support surface. The height of the lifting movement of the gripper device allows the container to swing to a vertical position. The gripper device is then lowered for placing the container upside down onto the support surface over the opening in an emptying position.

### AREA OF THE INVENTION

The present invention relates to a method and a device for emptying transport containers transported using transport units.

The use of known conveyor and order picking systems allows rapid and reliable order picking of products of all types. Order picking is performed either entirely automatically, semiautomatically, or manually as a function of the products. All variations share the feature of the use of transport containers, which are assigned to a specific order picking task. The products to be picked are placed either automatically or manually in these transport containers. The products may be put in the transport containers either packaged or open.

In addition to the products, a bill of delivery or an invoice is typically also put in the transport container.

On their path through an order picking system, the products are often decanted and change the transport container or after an order picking task has been assembled, the products are decanted from the transport container into a shipping container. The transport container is then transferred back to the circulation of the order picking system. However, packaging residues often remain in the container, which strongly reduce the volume in the container after multiple cycles in the order picking system, or make the decanting of the transport container more difficult. In particular, plastic films remaining in the container contribute to the transport container volume not being exploited optimally. Therefore, these packaging residues must be removed from the container interior.

In transport containers which are sent to final customers after passing through the order picking system, it may also occur that if these transport containers were previously used in an area of the order picking system where no shipping to final customers occurred, bills of delivery or invoices of the prior task are still located in the container. The erroneous shipping of these documents to the next customer must be reliably prevented solely for the reason of data protection, because of which manual emptying of these containers is typically necessary.

### PRIOR ART

A device for automatically emptying a container using a pivotable arm and tongs which enclose the containers on all sides is known from DE 30 45 145 A1.

Because of its complex clamping, which is only tailored to a fixed container shape, and the purely mechanically controlled actuating drive for pivoting and rotating the container, this device has been shown to be inflexible and requires a comparatively long time to empty a single container. This device also occupies additional space because of the 180° pivot movement which is executed and the provision of a second, parallel conveyor belt.

A device in which a container supplied using a conveyor belt is engaged on laterally projecting tabs by two pivot arms which may be raised vertically in a frame and is emptied at an intended location is known from U.S. Pat. No. 3,291,329 A.

In this case as well, a purely mechanically forced movement procedure is again performed during the entire emptying, which has been shown to be too sluggish and slow for the requirements of modern conveyor line production. Residual materials possibly remaining in the container must be discarded manually as before.

### DESCRIPTION OF THE INVENTION

It is therefore the object of the present invention to avoid these disadvantages and provide a device which allows rapid and automated emptying of the containers.

This object is achieved according to the present invention by a method having the characterizing features of claim 1 and a device having the characterizing features of claim 5.

It is thus possible to free the transport container entering the device of waste material and to guarantee that the transport container is completely empty for the next use. The method according to the present invention and/or the device according to the present invention may be performed or positioned at any arbitrary point in an order picking system or a conveyor technology, depending on from which position free transport containers must be guaranteed to be provided. It is especially important that the transport container to be emptied is clamped reliably and essentially punctually at diametrically opposite areas of its side walls. The punctual clamping is of great significance because the imaginary connection of the two clamping points forms an axis of rotation around which the transport container swings as it is lifted by the gripping device. The transport container must be lifted high enough that it no longer contacts the support surface and free swinging around the cited axis of rotation is possible. Because of the movement energy of the transport container, as it is lifted, it swings beyond or through a vertical position in which the transport container would remain if it was allowed to swing to a stop. The lowering of the gripping device must be tailored exactly and may occur first when the transport container is in its position swung through, i.e., shortly before swinging back. Due to the lowering in this position, there is a contact between the lowermost edge of the transport container and the support surface, through which swinging back is prevented. The further lowering of the gripping device causes the reversed laying of the transport container on the support surface over its opening and thus the completion of the rotation by 180° around the cited axis of rotation and, in further sequence, its emptying.

This procedure is now repeated according to the present invention, i.e., the gripping device again clamps the transport container, now laying reversed on the support surface over the opening, in order to lift it and lower it again after it swings beyond or through a vertical position and release it for further transport.

A preferred embodiment of the method according to the present invention and a preferred embodiment of the device according to the present invention provide stops against which the transport container moves in its starting position. The stops allow exact positioning of the transport container in this starting position, through which exact clamping and lifting by the gripping device is made possible. This is important because the transport container must be rotated exactly above the opening of the support surface to allow the emptying onto waste containers situated below this opening.

It is also noted here that this type of emptying is only considered for transport containers having a total weight of not more than 2.5 kg, including contents, and thus not for the decanting or emptying of products per se.

For secure clamping, the gripping device is implemented as rubber blocks which may be pressed against the side wall. These prevent the transport container from slipping through and allow the rotation of the transport container around the axis of rotation formed by the imaginary connection of the rubber blocks.

The method according to the present invention and the device according to the present invention also provide light barriers which monitor the positioning of the transport container in the starting position and, in addition, its removal after the emptying. The controller prevents activation of the gripping arms before a container which is not emptied has been removed from the intake area of the emptying device and/or only starts an emptying procedure when the transport container is located in the starting position.

In a preferred embodiment of the present invention, the lifting of the transport containers is implemented using two different gripping devices, one gripping device being responsible for the first 180° rotation of the transport container from its starting position and the other gripping device being responsible for the following 180° rotation into the removal position.

The width of the support surface is tailored according to the present invention to the container width and the boundary areas running in the transport direction are provided with L-shaped edges to form a guide for the containers.

As an alternative, the at least one opening of the support surface may also be provided with L-shaped guide rails for guiding the container on its edges running parallel to the transport direction of the container.

### BRIEF DESCRIPTION OF THE FIGURES

The present invention is explained in greater detail in the following on the basis of the attached drawings.

FIG. 1 shows a perspective view of a schematically illustrated emptying device according to the present invention,

FIG. 2 shows a side view of the emptying device from FIG. 1 in a first work step, in which the transport container is engaged by a first gripping device,

FIG. 3 shows a side view of the emptying device from FIG. 1 in a second work step, in which the gripping device, and thus the transport container, are raised,

FIG. 4 shows a side view of the emptying device from FIG. 1 in a third work step, in which the gripping device has been raised far enough that the transport container performs a swinging movement around a vertical axis.

FIG. 5 shows a side view of the emptying device from FIG. 1 in a fourth work step, in which the gripping device has been lowered again, so that the transport container comes to rest on a support surface with its open side down,

FIG. 6 shows a side view of the emptying device from FIG. 1 in a fifth work step, in which the gripping device and thus the transport container are raised again,

FIG. 7 shows a side view of the emptying device from FIG. 1 in a sixth work step, in which the gripping device has been raised far enough that the transport container performs a pivot movement around a vertical axis, and

FIG. 8 shows a side view of the emptying device from FIG. 1 in a seventh work step, in which the gripping device has been lowered again, so that the transport container comes to rest on the support surface with its open side on top.

### WAYS OF IMPLEMENTING THE INVENTION

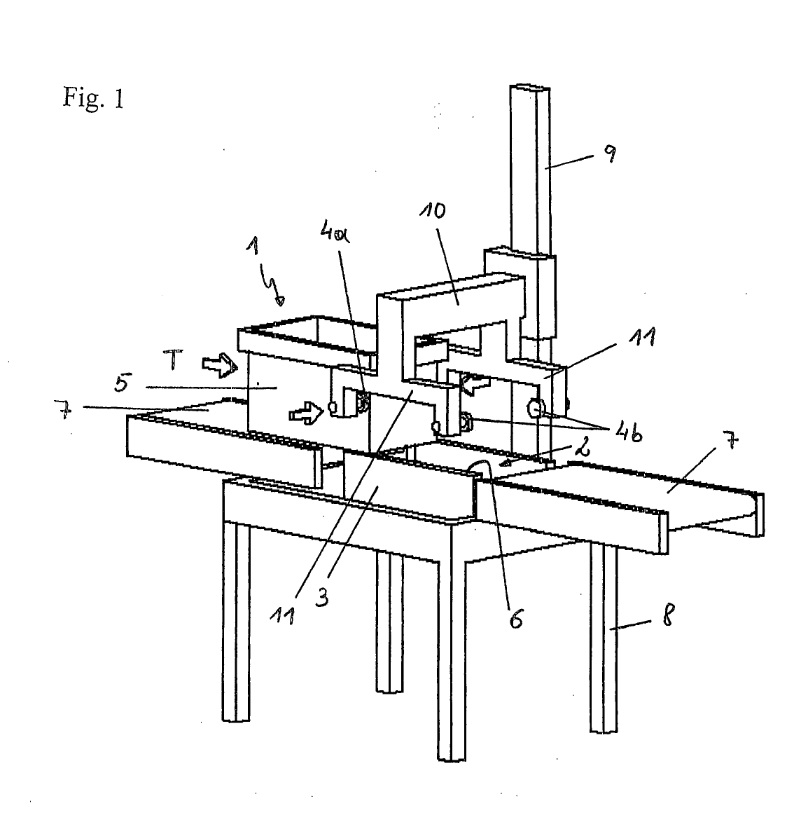

FIG. 1 shows a perspective view of a schematically illustrated emptying device according to the present invention. Transport containers 1 are guided along a transport direction T to the emptying device via a transport unit, such as a conveyor belt having a transport surface 7. The continuation of the transport unit, via which the emptied containers 1 are removed again from the emptying device, is located at the diametrically opposite end of the emptying device. The emptying device is provided for the purpose of removing packaging residues, bills of delivery, rubbish, or similar material from the containers 1, for which merely turning over the container 1 is sufficient, but not for decanting or emptying products per se. The transport containers 1 are comparatively small containers, which are used for assembling products in the framework of order picking systems, for example, and typically have a total weight of not more than 2.5 kg including contents.

The emptying device essentially comprises a support surface 3, which defines an opening 2. The support surface 3 is used for the purpose of mounting the transport container 1 so that the opening of the transport container 1 is oriented downward, so that its contents may fall through the opening 2 defined by the support surface 3. The support surface 3 may be formed by a frame, for example, or also solely by two strips, rails, bearing blocks, or similar items oriented parallel to the transport direction T. The width of the support surface 3 is tailored to the width of the container 1, and may not exceed the width of the container 1. Furthermore, the support surface 3 may be provided with L-shaped edges in its boundary areas running in the transport direction T, to form a guide for the containers 1. Alternatively to this, the at least one opening 2 of the support surface 3 may also be provided on its edges running parallel to the transport direction T of the container 1 with L-shaped guide rails for guiding the container 1. According to the embodiment shown in FIG. 1, the support surface 3 is attached to a frame 8. In the embodiment shown, the width of the support surface 3 additionally corresponds to the width of the containers 1, this width being less than the width of the transport surface 7.

Furthermore, a lifting and lowering device is attached to the frame 8, which is formed in the embodiment shown in FIG. 1 by a vertical guide 9, as well as a horizontal lift slide 10, which is situated so it is movable on the guide 9. The lift slide 10 is movable along the guide 9 in the vertical direction, the particular lifting and lowering movement of the lift slide 10 being controlled and monitored by a control unit (not shown in FIGS. 1 through 8). Corresponding drive units for the lift slide 10 are also not shown in FIGS. 1 through 8, but are provided, of course. Connection supports 11 project laterally from the lift slide 10, to which the gripping devices 4a, 4b are attached. In the embodiment shown in FIG. 1, two pairs of gripping devices 4a, 4b, each of which are diametrically opposite, are provided, but it would also be conceivable to only provide one pair of diametrically opposite gripping devices 4a, horizontal mobility of the gripping devices 4a having to be ensured in this case, as described in the following.

The two gripping devices 4a are movable in a direction perpendicular to the transport direction T, i.e., they may be moved toward one another or away from one another. Corresponding drive units are provided for this purpose, but are not shown in FIGS. 1 through 8. The two gripping devices 4b of the second pair are also movable in a direction perpendicular to the transport direction T, i.e., they may also be moved toward one another or away from one another. Corresponding drive units are provided for this purpose, but are again not shown in FIGS. 1 through 8. For secure clamping, the gripping devices 4a, 4b are implemented as rubber blocks which may be pressed against the side wall of the containers 1. These prevent the transport container 1 from slipping through and allow the rotation of the transport container 1 around the axis of rotation formed by the imaginary connection of the rubber blocks, as will be explained in greater detail.

A preferred embodiment of the method according to the present invention and a preferred embodiment of the device according to the present invention provide stops (not shown in FIGS. 1 through 8), against which the transport containers 1 move in a starting position. The stops allow exact positioning of the transport container 1 in the starting position, through which exact clamping and lifting by the gripping devices 4a, 4b is also possible. This is important because the transport container 1 must be turned over exactly above the opening 2 of the support surface 3 to allow the emptying onto waste containers (not shown in FIGS. 1 through 8) situated below this opening 2.

The method according to the present invention and the device according to the present invention also provide light barriers (not shown in FIGS. 1 through 8), which monitor the positioning of the transport containers 1 in the starting position and, in addition, their removal after emptying. Through suitable control of the emptying device, activation of the gripper arms 4a, 4b is prevented before a container 1 which has not been emptied is removed from the intake area of the emptying device, or starts an emptying procedure only when a transport container 1 is in the starting position.

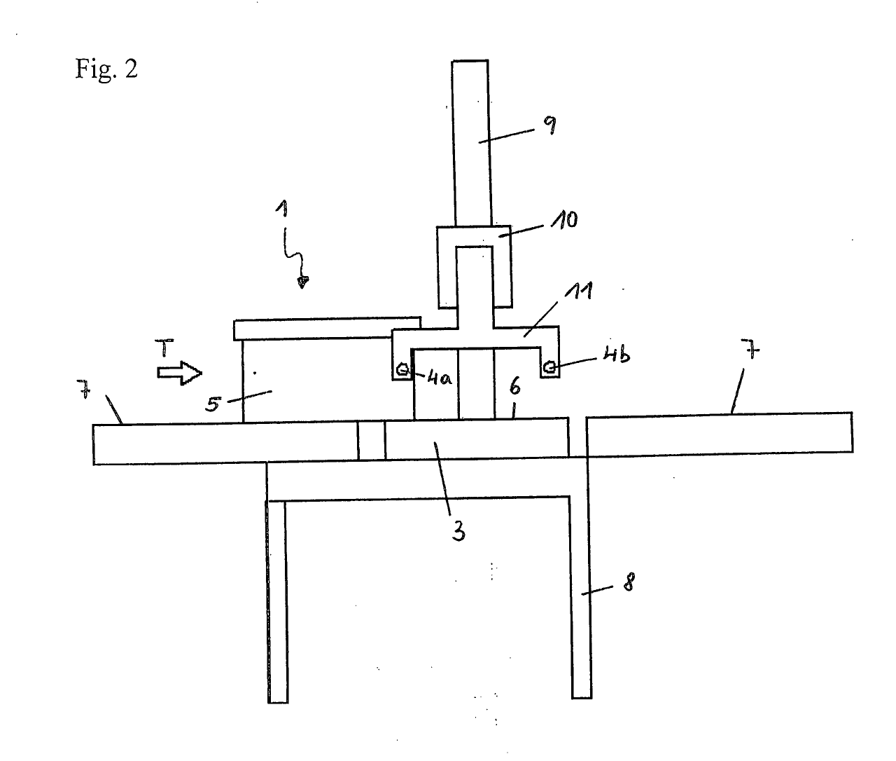

The method according to the present invention is explained in greater detail on the basis of FIGS. 2 through 8. As shown in FIG. 2, in a first work step, a transport container 1 which rests on the transport surface 7 of a transport unit is first moved up to the emptying device according to the present invention. In further sequence, it stops at a stop (not shown in FIG. 2) and is detected by light barriers which activate the gripping devices 4a. The gripping devices 4a are then moved toward one another, so that they press against the outer walls of the container 1 which are oriented parallel to the transport direction T at a defined contact pressure. The container 1 is thus engaged by the first gripping device 4a, the imaginary connection line between the two contact pressure points of the gripping devices 4a defining an axis of rotation, as will be explained in greater detail in the following.

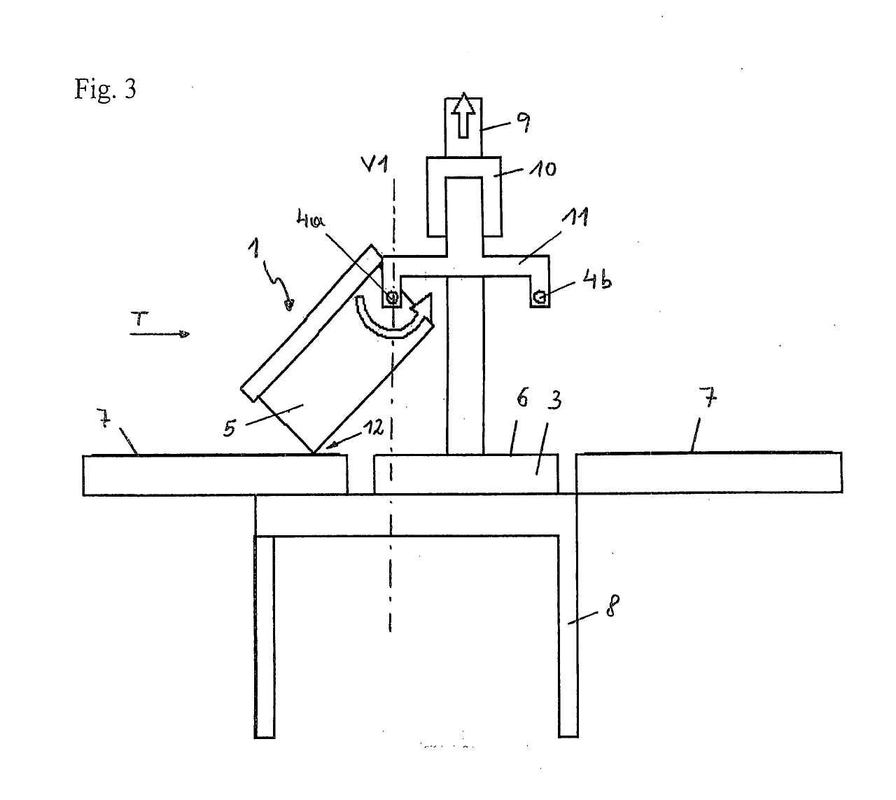

As shown in FIG. 3, in further sequence, the lift slides 10 are raised with the aid of a control unit and a drive unit (not shown in FIG. 3), through which the container 1 is also raised and is only supported by the lower transverse edge 12, facing away from the contact pressure points of the gripping devices 4a, on the transport surface 7. As the lift slide 10 is raised further, this lower transverse edge 12 of the container 1 slips closer and closer to the emptying device, the container 1 being tilted increasingly.

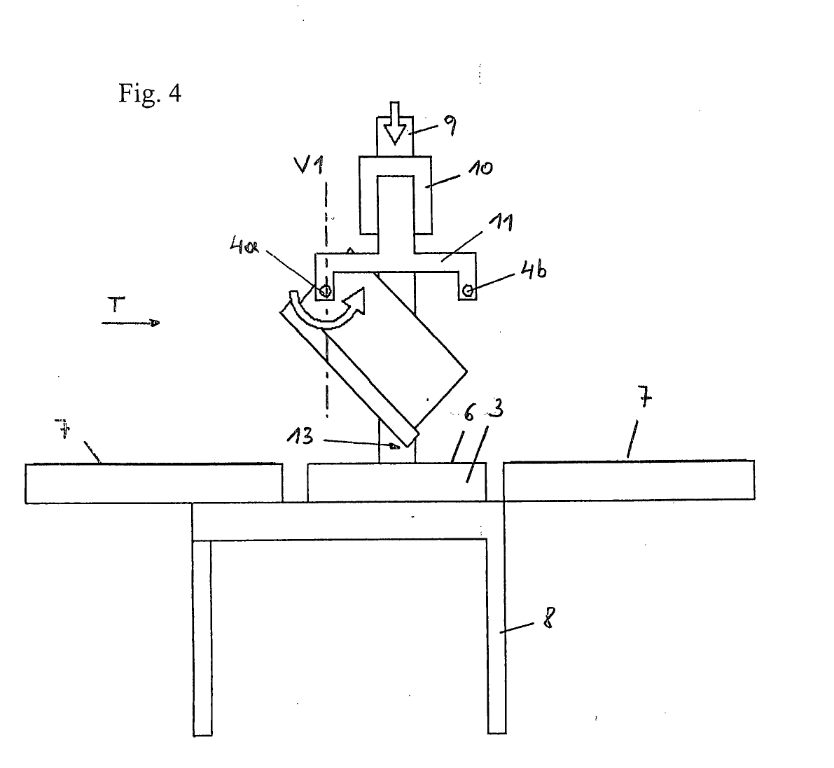

At a sufficient height of the lift slide 10, the lower transverse edge 12 of the container 1 is finally also lifted off of the transport surface 1, so that the container 1 performs a swinging movement around the vertical axis V1 (FIG. 4). However, the container 1 is prevented from swinging back into the position shown in FIG. 3 because the lift slide 10 is lowered again, so that an upper edge 13 of the container 1 hits the support surface 3 as it swings back. The lift slide 10 is now lowered increasingly, the upper transverse edge 13 slipping along the upper support edges 6 in the transport direction T.

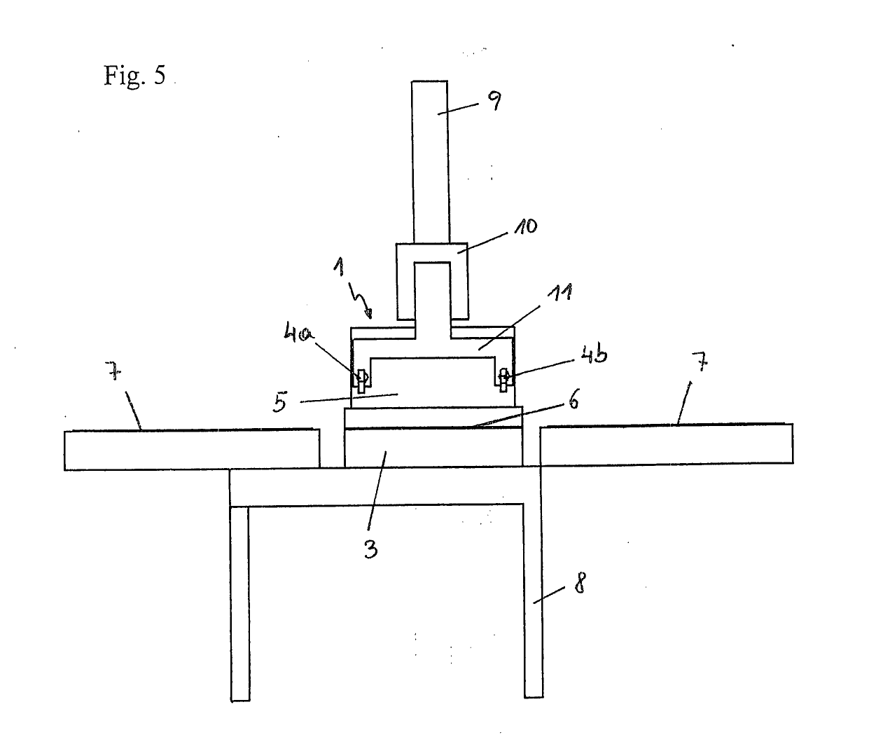

Finally, the position shown in FIG. 5 is achieved, in which the transport container 1 comes to rest with its open side downward on the support surface 3, through which possible residues in the container 1, such as packaging material, bills of delivery, rubbish, or the like fall out of the container 1 and through the opening 2, where they are captured by a collection container (not shown in FIG. 5).

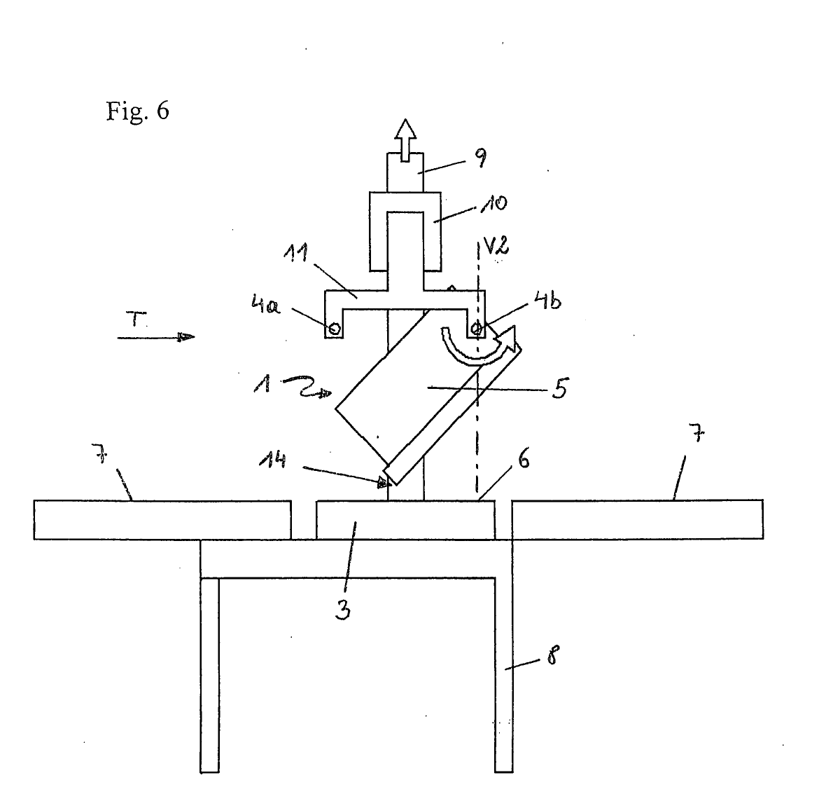

After a defined dwell time in the position shown in FIG. 5, the gripping device 4a is lifted off of the outer walls 5 of the container 1, and the container 1 is thus released again. In further sequence, the gripping devices 4b are moved toward one another, so that they press against the outer walls of the container 1 which are oriented parallel to the transport direction T at a defined contact pressure force. The container 1 is thus engaged by the second gripping device 4b, the imaginary connection line between the two contact pressure points of the gripping devices 4b again defining an axis of rotation. If the lift slides 10 are raised again, the container 1 is also raised again, but the container 1 now slips on its second, upper transverse edge 14 along the upper support edge 6 in the transport direction T (FIG. 6).

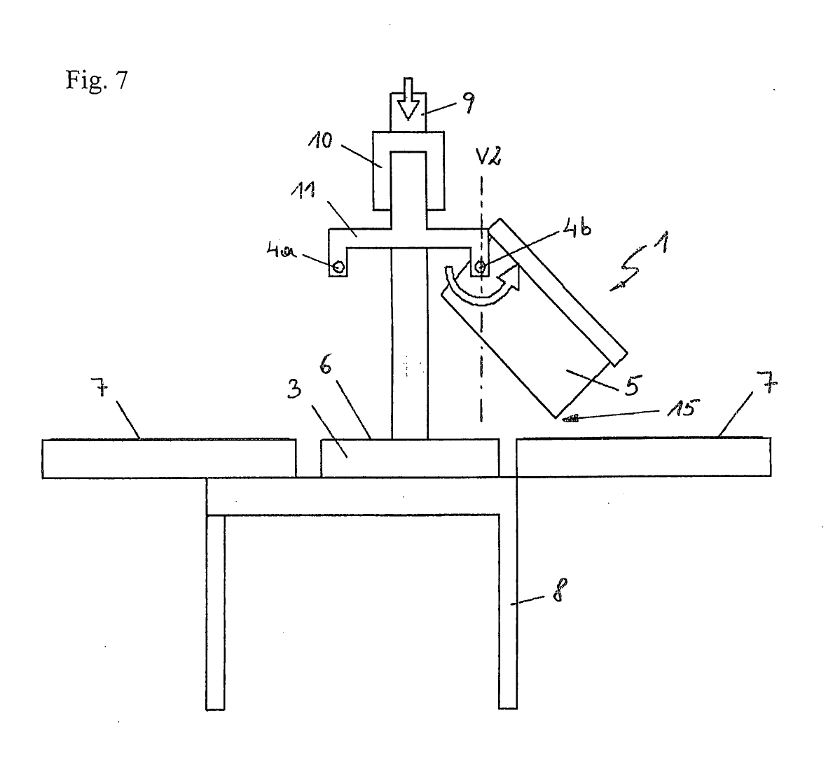

Finally, at a sufficient height of the lift slide 10, the transverse edge 14 of the container 1 is also lifted off of the support surface 3, so that the container 1 performs a swinging movement around the vertical axis V2 (FIG. 7). The container 1 is again prevented from swinging back into the position shown in FIG. 6 by lowering the lift slide 10 again, so that the second, lower transverse edge 15 of the container 1 hits the support surface 3 or the transport surface 7 as it swings back, depending on the spatial extension of the support surface 3. The lift slide 10 is now increasingly lowered, the transverse edge 15 slipping along the upper support edges 6 or along the transport surface 7 in the transport direction T.

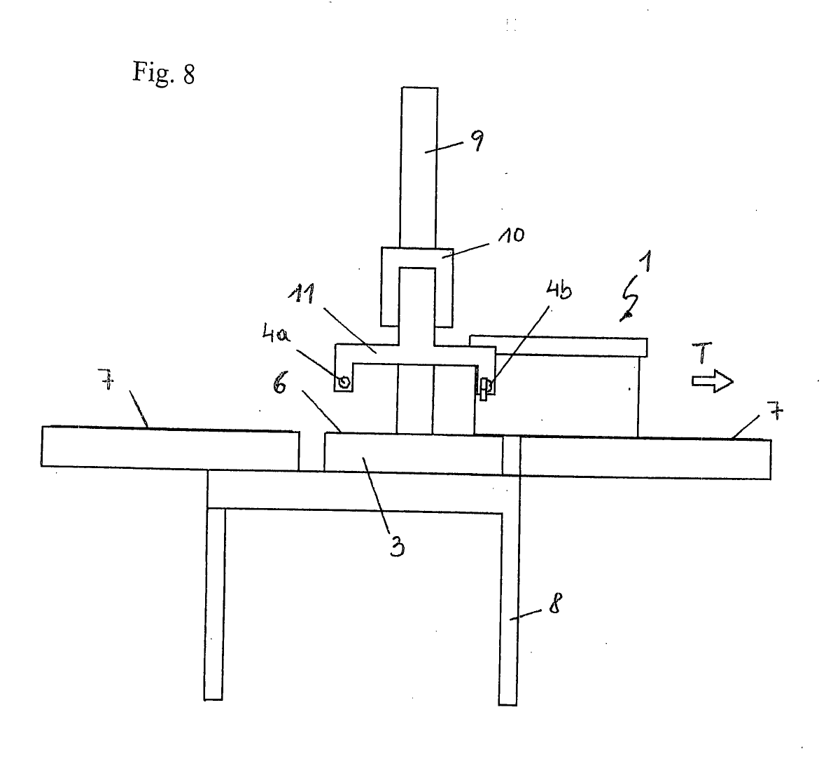

Finally, the position shown in FIG. 8 is reached, in which the transport container 1 comes to rest with its open side on top on the support surface 3 or the transport surface 7. The emptied container 1 may be transported further in this position and supplied to filling stations, for example.

The present invention thus allows automatic emptying of the container in a simple way.

1. A method for emptying a transport container (1) conveyed using transport units, which is moved to a defined starting position on a support surface (3), engaged using a gripping device (4a, 4b) on its outer walls, and lifted by vertically moving the gripping device (4a, 4b), comprising the following method steps:
engaging the transport container (1) by clamping it on its outer walls parallel to the transport direction (T) essentially punctually, so that free pivoting of the transport container (1) is permitted
lifting the transport container (1) by vertically moving the gripping device (4a, 4b) by a distance which allows the transport container (1) to swing through beyond a vertical (V1) orientation
lowering the transport container (1) in its state as it has swung through and laying it on a support surface (3) having an opening (2)
and preferably
engaging the transport container again by clamping it on its outer walls parallel to the transport direction (T) essentially punctually again using a gripping device (4a, 4b), so that free pivoting of the transport container (1) is permitted
lifting the transport container (1) by vertically moving the gripping device (4a, 4b) by a distance which allows the transport container (1) to swing through beyond a vertical (V2) orientation
lowering the transport container (1) in its state as it has swung through and laying it partially on the transport unit (7).

2. The method according to claim 1, wherein the transport container (1) is clamped on the front half of the transport container (1), viewed in the transport direction (T).

3. The method according to claim 1, wherein the provision of the transport container (1) in the starting position is monitored using a sensor.

4. The method according to claim 1, wherein the removal of the emptied transport container (1) is monitored using a sensor.

5. A device for emptying transport containers (1) transported using transport units, comprising a vertically movable gripping device (4a, 4b) for lifting and emptying the transport container (1), characterized in that a support surface (3) having at least one opening (2) is provided below the gripping device (4a, 4b) and the gripping device (4a, 4b) has clamping jaws for clamping the transport container (1) on its side walls (5) parallel to the transport direction (T), the vertical lift path of the gripping device (4a, 4b) at least corresponding to a length which allows the transport container (1) to swing through beyond its vertical position (V1) and a controller being provided which, after the transport container (1) has swung through once, lowers the gripping device (4a, 4b) to the support surface (3) over the opening (2) to prevent the transport container (1) from swinging back into its inertial position.

6. The device for emptying transport containers according to claim 5, wherein two different gripping devices (4a, 4b) are provided, and the lifting from the starting position and the lifting from the emptying position are each performed by one of these gripping devices (4a, 4b).

7. The device for emptying transport containers according to claim 5, wherein a stop is provided, against which the container (1) is positioned before first being lifted.

8. The device for emptying transport containers according to claim 5, wherein a light barrier used for establishing the position of the container (1) entering the device is situated in front of the first gripping device (4a), viewed in the transport direction (T) of the container (1).

9. The device for emptying transport containers according to claim 5, wherein a light barrier used for establishing the position of the container (1) leaving the device is situated after the second gripping device (4b), viewed in the transport direction (T) of the container (1)

10. The device for emptying transport containers according to claim 5, wherein the gripping devices (4a, 4b) are rubber blocks (4a, 4b) which may be pressed laterally against the container walls.

11. The device for emptying transport containers according to claim 5, wherein the width of the support surface (3) is tailored to the container width and the boundary areas running in the transport direction (T) are provided with L-shaped edges (6) to form a guide for the containers (1).
